(19) United States
(12) Patent Application Publication
(10) Pub. No.: US 2014/0067856 A1
(43) Pub. Date: Mar. 6, 2014

(54) SYSTEMS AND METHODS FOR FACILITATING DIAGNOSIS AND PRODUCT IDENTIFICATION FOR PATIENTS REQUIRING CONTINENCE PRODUCTS

(71) Applicant: BrightSky Australia, Newington NSW (AU)

(72) Inventors: Kylie Wicks, Engadine NSW (AU); David Sinclair, Rydalmere NSW (AU); Birgitte Maibom, Beecroft NSW (AU); Elke Krishnan, Kellyville NSW (AU)

(21) Appl. No.: 14/018,681

(22) Filed: Sep. 5, 2013

(30) Foreign Application Priority Data
Sep. 5, 2012 (AU) 2012903869

(51) Int. Cl. G06F 17/30

(52) U.S. Cl. CPC G06F 17/30477
USPC 707/769

(57) ABSTRACT

Systems and methods for facilitating diagnosis and product identification for patients requiring continence products. Embodiments of the invention have been particularly developed there by to provide a software application (for example an iOS or Android application) thereby to assist a clinician and/or patient in identifying appropriate continence products for a given set of patient requirements. While some embodiments will be described herein with particular reference to that application, it will be appreciated that the invention is not limited to such a field of use, and is applicable in broader contexts.

### CROSS-REFERENCE TO RELATED APPLICATIONS

This application claims priority to Australian patent application No. 2012903869 filed on Sep. 5, 2012, the disclosure of which is incorporated in its entirety by reference herein.

### FIELD OF THE INVENTION

The present invention relates to systems and methods for facilitating diagnosis and product identification for patients requiring continence products. Embodiments of the invention have been particularly developed there by to provide a software application (for example an iOS or Android application) thereby to assist a clinician and/or patient in identifying appropriate continence products for a given set of patient requirements. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

The existence of various continence related medical conditions are well-known in the medical community. Patients suffering from continence related conditions are typically assessed by a healthcare professional and given a continence treatment or management plan specific to their condition. Such treatment plans often involve the prescription of continence products for the patients.

There exist many hundreds of continence management products on the market, varying in purpose, style, size and brand. It is often difficult for healthcare professionals to be aware of the full spectrum of products available and to find suitable information on each product to confidently prescribe products to their patients. Searching for the most suitable produce for a patient can often be time intensive for the healthcare professional.

There is a need in the art for improved systems and methods for facilitating diagnosis and product identification for patients requiring continence products.

### SUMMARY OF THE INVENTION

It is an object of the present invention to overcome or ameliorate at least one of the disadvantages of the prior art, or to provide a useful alternative.

One embodiment provides a computer implemented method for facilitating continence product identification for a patient, the method including the steps of:
maintaining access to a database of continence products, wherein each product is described by reference to a set of product parameters;
providing an interface thereby to enable user-selection of a category of continence product based on an initial clinical assessment of the patient;
based on the user-selection of a category of continence product, determining a set of questions, and providing an interface configured to obtain patient parameter data from the user in relation to that set of questions; and
based on obtained patient parameter data, querying the database thereby to identify one or more products of the product category for which the obtained patient parameter data corresponds with the product parameters.

The method preferably further includes providing an interface for enabling the user to place an order in respect of a user-selected one of the identified one or more products. Preferably, the method further includes providing an interface thereby to enable the user to obtain data to facilitate generation of a prescription for a user-selected one of the identified one or more products.

The data to facilitate generation of a prescription is preferably delivered to the user via a designated email address. The category of continence product is preferably selected from the list including: pads, catheters; and uridomes/sheaths.

The interface is preferably configured to obtain patient parameter data includes a graphical interface.

In one embodiment, the product category is preferably continence pads, and the obtained patient parameter data preferably includes data indicative of required pad capacity. In another embodiment, the product category is continence pads, and the obtained patient parameter data preferably includes data indicative of required/preferred pad size. In another embodiment, the product category is preferably continence pads, and the obtained patient parameter data preferably includes data indicative of a patient size measurement. In a further embodiment, product category is preferably continence pads, and the obtained patient parameter data preferably includes data indicative of a patient incontinence parameters.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 is a flow diagram outlining the primary steps of a computer implemented method, carried out through a software application on a hardware device, for facilitating continence product identification for a patient;

FIG. 2 is a flow diagram outlining the steps in which a healthcare professional may utilise the methodology of FIG. 1 to provide a diagnosis and product identification for patients requiring continence products;

FIG. 3 illustrates schematically an exemplary system-level overview of hardware configured to carry out the methodologies of FIG. 1;

FIG. 4 is a schematic illustration of an iPhone displaying a cut out wheel interface according to one embodiment of the present invention; and

FIG. 5 is a schematic diagram of the product selection path of the Catheter Compass tool.

### DETAILED DESCRIPTION

The present invention relates to systems and methods for facilitating diagnosis and product identification for patients requiring continence products. Embodiments of the invention have been particularly developed there by to provide a software application (for example an iOS or Android application) thereby to assist a clinician and/or patient in identifying appropriate continence products for a given set of patient requirements. While some embodiments will be described herein with particular reference to that application, it will be appreciated that the invention is not limited to such a field of use, and is applicable in broader contexts.

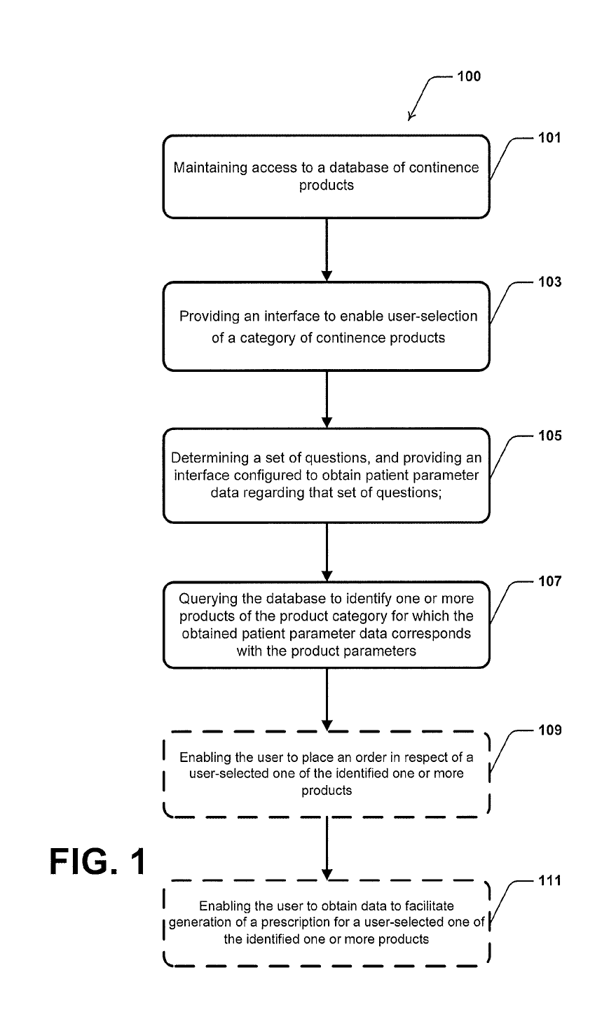

Referring initially to FIG. 1, there is illustrated one embodiment of a computer implemented method 100, carried out through a software application on a hardware device, for facilitating continence product identification for a patient. Hardware devices used to implement the method include a personal computer, laptop or mobile device such as a Smartphone, Tablet, PDA or laptop computer.

Initially, at step 101, a database of continence products is defined and access to that database is maintained such that the application is able to access the database upon a request by a user of the application. In one embodiment, the database is maintained in an online server that is accessed by users on hardware devices through an Internet connection. Each product in the database is described by reference to a set of product parameters, including product name, model, size, type, code, manufacturer and cost. The parameters may also include other information such as product review data and user feedback data.

At step 103, the application is presented to the user through a graphical interface to enable user-selection of a category of continence products based on an initial clinical assessment of the patient by a healthcare professional. In the case of Smartphones or Tablet devices, the interface may be configured to receive user input by way of touch inputs. In other computing devices, user input is provided through other input devices such as keyboards and a mouse. Example categories of continence products include pads, catheters, uridomes/sheaths.

At step 105, based on the user-selection of a category of continence product, a set of questions is determined. The interface then allows the user to input patient parameter data in relation to that set of questions. At step 107, based on the obtained patient parameter data, the database is queried to identify one or more products of the product category for which the obtained patient parameter data corresponds with the product parameters.

In the case where the product category selected is continence pads, the obtained patient parameter data includes data indicative of one or more of required pad capacity, required/preferred pad size, a patient size measurement and/or patient incontinence parameters. In other embodiments, the interface prompts the user for different patient parameter data. In another embodiment, if the user and/or a patient provides suitable permission, the interface is able to access online medical records of a patient to ascertain further patient parameter data.

The user of the interface is generally a healthcare professional who carries out the initial clinical assessment of the patient or a related professional who is treating the patient. Examples of this type of user include doctors and nurses trained in the assessment, diagnosis and treatment of continence related medical conditions. The user may also be the patient themselves. For example, a patient with sufficient knowledge of their condition and/or treatment plan may use the application to identify alternative or better value products available on the market.

At step 109 the interface optionally also enables the user to place an order in respect of a user-selected one of the identified one or more products. At step 111, the interface optionally enables the user to obtain data to facilitate generation of a prescription for a user-selected one of the identified one or more products. The data to facilitate generation of a prescription is delivered to the user via a designated email address. However, in other embodiments, this data is delivered to the user by other means such as data accessible through a web interface, text message or physical delivery of the data in hard copy.

In some embodiments, the above described methodology is able to be performed on a computer through an executable computer program configured to perform the methods. In one embodiment, the computer program is contained on a non-transitive carrier medium, such as a CD-ROM, DVD or solid-state memory device, which carries computer executable code that, when executed on a processor, causes the processor to perform the above described methods.

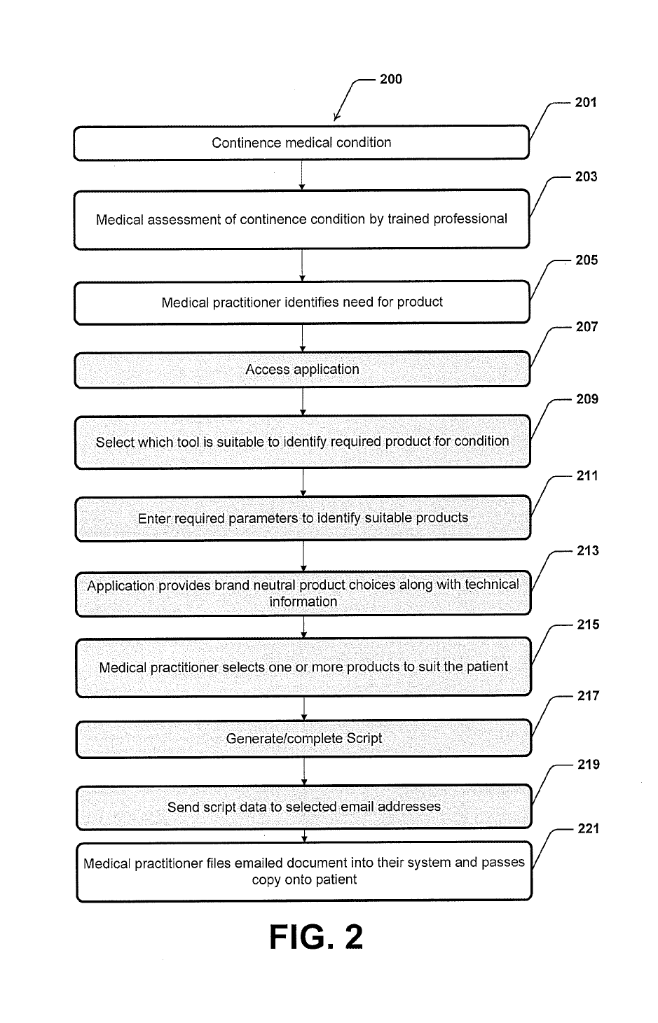

Referring now to FIG. 2, there is illustrated a method 200 the steps in which a healthcare professional may utilise the above described methodology to provide a diagnosis and product identification for patients requiring continence products. The steps in grey colour indicate steps carried out using the software application described above. At step 201 a patient identifies to a healthcare professional that they require assistance with a continence related medical condition. At step 203, the healthcare professional carries out a medical assessment of the continence condition. At step 205, the need for a continence product is determined. Not all cases will require a product as part of the management of the individual's condition.

At step 207 the (or another) healthcare professional accesses the software application. By way of example, the professional may access the application as an App on a Smartphone such as an Apple iPhone. In using the application, at step 209, the healthcare professional uses the graphical interface to select a particular tool, from among a plurality of tools, which is suitable to identify product categories or required product information for the particular patient condition. For example, if the patient's condition indicates that a catheter is required, a catheter selection tool is selected. Examples of particular tools are outlined below in the example implementation section. At step 211, the healthcare professional enters patient parameter data in response to a set of question prompts presented at the interface. The input patient parameter data acts as filter inputs for identifying suitable products. At step 213, the application accesses the database and provides brand neutral product choices, together with technical information of each choice to allow for any special or unique circumstances of the patient. Alternatively, the displayed products may be displayed according to brand or filtered by the particular brand. At step 215, the healthcare professional selects one or more products from the list which are suitable for the patient's medical condition.

Upon selection of a product, at step 217, the interface presents the healthcare professional with the option to generate or complete a script. Additional products may be selected and added to the script, as well as any additional information or instructions that the healthcare professional believes the patient might require. At step 219, the completed script is sent to a designated email address of the healthcare professional. In one embodiment, the email address belongs to the healthcare professional who is treating the patient, who can then pass the script onto the patient. In another embodiment, the script is also emailed directly to the patient. In a further embodiment, the selection of a particular product links the healthcare professional with a website of a supplier of that product, where purchase of the product can be made. Finally, at step 221, the emailed script is filed into the healthcare professional's file and recorded against the patient's medical file as per legal and/or regulatory requirements. A copy of the script or related information is passed onto the patient.

### Exemplary System-Level Overview

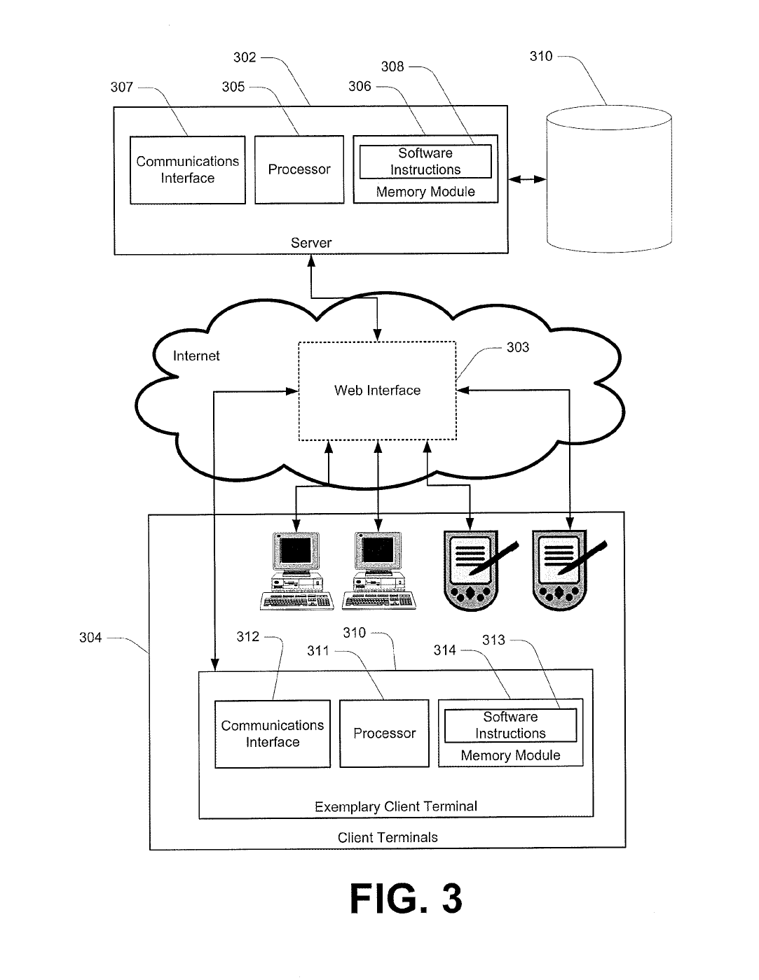

In some embodiments, methods and functionalities considered herein are implemented by way of a server, as illustrated in FIG. 3. In overview, a web server 302 provides a web interface 303. This web interface is accessed by users (healthcare professionals or patients) by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310 configured for storing information relating to continence products. In further embodiments the database leverages memory module 306. In one embodiment, database 310 is linked with online systems and records and is automatically periodically updated. In other embodiments, system administrators access database 310 through server 302 to maintain and periodically update the data contained within database 310.

Web interface 303 is accessed by users of mobile devices, such as Smartphones or Tablet computers, by way of an App type software application. This App is downloaded to the mobile device and executed locally on the device. The user provides inputs, for example, through touch-based inputs, in response to interface prompts. The input data is transferred to server 302 which accesses database 310 to retrieve continence product information. In these embodiments utilising Apps or other proprietary software, client terminals 304 maintain software instructions for a computer program product that essentially provides access to a portal via which framework 100 is accessed.

In other embodiments web interface 303 includes a website which may be accessed by users on client terminals 304. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Example Implementation

In one embodiment, the above described systems and methods are implemented through an iOS compatible proprietary software application such as an iPhone or iPad App. The App is proposed to be distributed through the Apple Store and made available at a small fee. It may also be made available on one or more web stores to some selected prescribers. In another embodiment, an Android-based App is created for use on mobile devices running the Android software.

The App includes a splash screen (initial launch screen of the App) and a home screen which permits navigation to four main categories or tools: The PadNavigator, the Catheter Compass, the Dome Director, and an “About” section, used to promote new products, highlight sale and clearance items, and distribute other information about the company (news, events etc). The PadNavigator tool assists healthcare professionals with selecting suitable continence pads for patients. The Catheter Compass tool assists in identifying suitable catheters for patients. Similarly, the Dome Director tool aides in identifying suitable uridomes/sheaths for patients. These three categories or product represent the three main continence products on the market today. The App is configured to be able to incorporate new categories or tools as new products become available.

Separate search tools are utilised as the type of product required necessitates the prompting of very different questions and filters to select the correct product. This is partly due to a very large range of market available products: around 500 pads, 500 catheters and 200 uridomes/sheaths. In some embodiments, a variety of products will be selected to suit different daily requirements, e.g. for home and when going out.

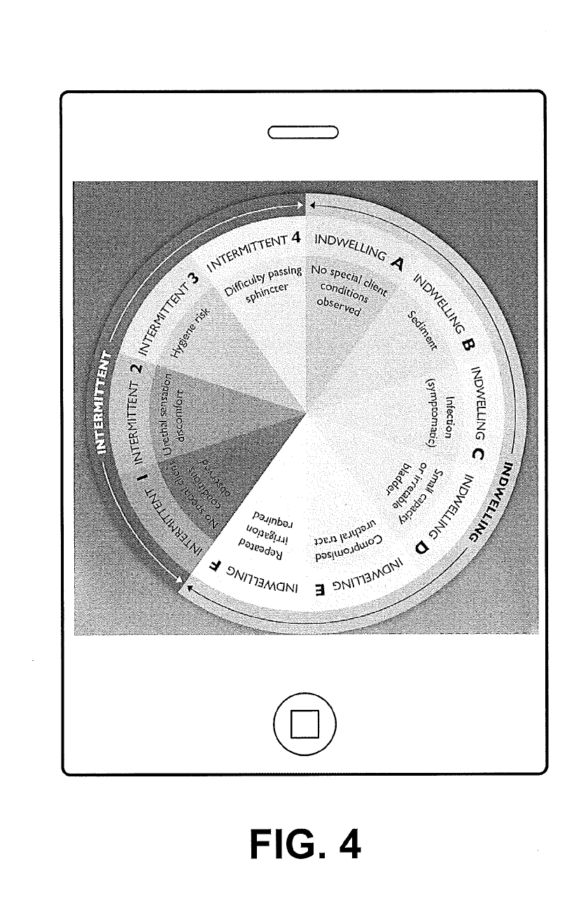

Each tool within the App provides a cut out wheel display as shown in FIG. 4. The user is able to manipulate the cut out wheel displayed on the touch screen through various touch gestures applied to the screen to select filter parameters and select products in accordance with a continence assessment test.

Within the PadNavigator tool, categories are listed as per their waist measurement and appropriate continence pads are suggested. Product filter parameters include sex of the patient, patient mobility, wear time, pad capacity, type of pad and size of pad. Three main types of pads that are searchable in the PadNavigator are referred to as:

Pads

Pull-Up Style (also known as ‘pant style’)

All-In-One Style (also known as ‘nappy style’)

The user will then be able to select the pads from the generated list or product guide and place an email order using the iPhone or iPad's native email function.

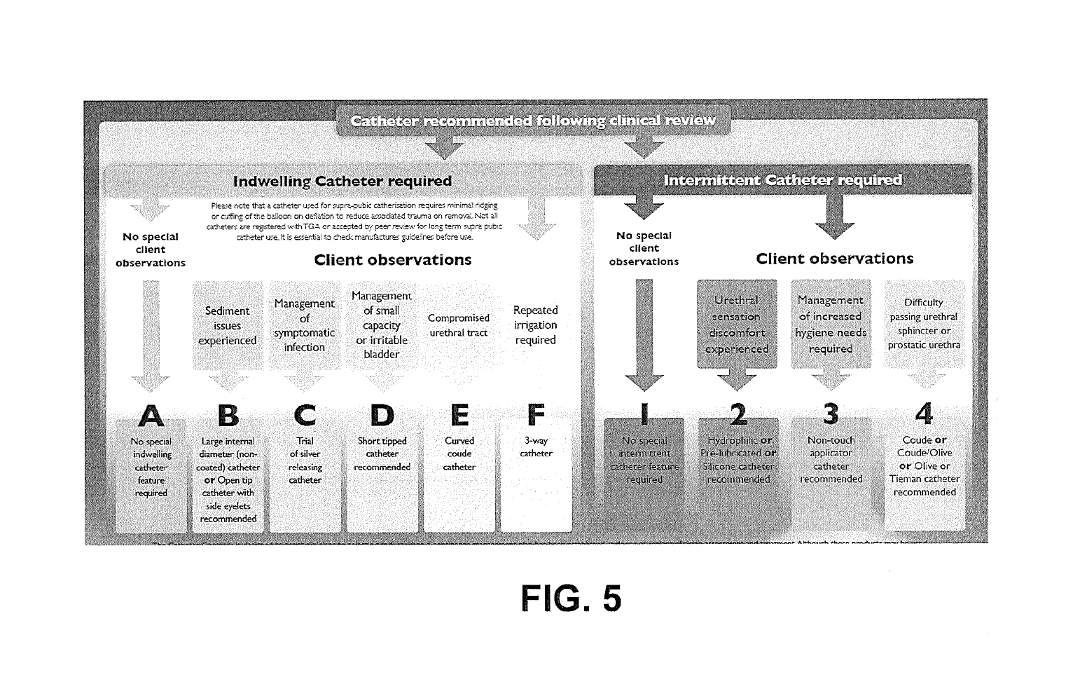

Within the Catheter Compass tool the user can use a touch control to identify the type of catheter that best meets the needs of a patient, see a summary of options from the Catheter Compass Product Selection path, view the Catheter recommended clinical review, and refer to a Catheter Product Guide to select products which can be ordered using the iPhone or iPad's native email function. The product selection path of the Catheter Compass tool is summarised schematically in FIG. 5.

Within the Dome Director tool, the user is able to read the details about uridome/sheath products and the steps to use them, view the categories as per individual cases, read helpful tips, and view the Dome Director Sizing Guide and select the size as per the personal application. The user can then check uridome/sheath products as per the categories and order these using the iPhone or iPad's native email function.

Additional features of the App include the ability to track purchases (adding usage and reminders for users to buy or renew their orders) and a “news feed” section which will be used to push new products, highlight sales and clearance items and other information about the company (news and events).

### CONCLUSIONS AND INTERPRETATION

It will be appreciated that the disclosure above provides various significant systems and methods for facilitating diagnosis and product identification for patients requiring continence products.

The present invention allows a healthcare professional performing a continence assessment to:
Select an appropriate product search tool depending on the type of continence product required as per continence management plan.
Select the most suitable product based on its clinical features for an individual patient.
Populate a patient prescription form
Email the patient prescription form to the healthcare professional's email account, the patient or another party as required.

The present invention provides healthcare professionals with a clinical pathway that aids in the selection of continence treatment or management products, from the vast number available on the market, which best meets the needs of a patient.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for facilitating continence product identification for a patient, the method including the steps of:
maintaining access to a database of continence products, wherein each product is described by reference to a set of product parameters;
providing an interface thereby to enable user-selection of a category of continence product based on an initial clinical assessment of the patient;
based on the user-selection of a category of continence product, determining a set of questions, and providing an interface configured to obtain patient parameter data from the user in relation to that set of questions; and
based on obtained patient parameter data, querying the database thereby to identify one or more products of the product category for which the obtained patient parameter data corresponds with the product parameters.

2. The method according to claim 1 including providing an interface for enabling the user to place an order in respect of a user-selected one of the identified one or more products.

3. The method according to claim 1 including providing an interface thereby to enable the user to obtain data to facilitate generation of a prescription for a user-selected one of the identified one or more products.

4. The method according to claim 3 wherein the data to facilitate generation of a prescription is delivered to the user via a designated email address.

5. The method according to claim 1 wherein the category of continence product is selected from the list including: pads, catheters; and uridomes/sheaths.

6. The method according to claim 1 wherein the interface configured to obtain patient parameter data includes a graphical interface.

7. The method according to claim 1 wherein the product category is continence pads, and the obtained patient parameter data includes data indicative of required pad capacity.

8. The method according to claim 1 wherein the product category is continence pads, and the obtained patient parameter data includes data indicative of required/preferred pad size.

9. The method according to claim 1 wherein the product category is continence pads, and the obtained patient parameter data includes data indicative of a patient size measurement.

10. The method according to claim 1 wherein the product category is continence pads, and the obtained patient parameter data includes data indicative of a patient incontinence parameters.

11. A computer system configured to perform a method according to claim 1.

12. A computer program configured to perform a method according to claim 1.

13. A non-transitive carrier medium carrying computer executable code that, when executed on a processor, causes the processor to perform the method according to claim 1.
